(19) United States
(12) Patent Application Publication
(10) Pub. No.: US 2011/0113236 A1
(43) Pub. Date: May 12, 2011

(54) METHODS, SYSTEMS, AND COMPUTER READABLE MEDIA FOR OFFLOADING INTERNET PROTOCOL SECURITY (IPSEC) PROCESSING USING AN IPSEC PROXY MECHANISM

(76) Inventors: Sylvain Chenard, Gatineau (CA); Allain Legacy, Ottawa (CA); Donald Penney, Kanata (CA); Matthew Peters, Kanata (CA)

(21) Appl. No.: 12/938,077

(22) Filed: Nov. 2, 2010

Related U.S. Application Data
(60) Provisional application No. 61/257,266, filed on Nov. 2, 2009.

(51) Int. Cl. H04L 9/00

(52) U.S. Cl. 713/154

(57) ABSTRACT

Methods, systems, and computer readable media for offloading IPsec processing from application hosts using an IPsec proxy mechanism are disclosed. According to one method, at least one of unencrypted, IPsec, and Internet key exchange (IKE) packets transmitted between a first application host and a second application host are intercepted by a network gateway. The network gateway performs all IKE and IPsec-related processing for the at least one unencrypted, IPsec, and IKE packets on behalf of the first application host such that the second application host is unaware that IPsec processing is being performed by the network gateway.

### PRIORITY CLAIM

This application claims the benefit of U.S. Provisional Patent Application Ser. No. 61/257,266 filed Nov. 2, 2009; the disclosure of which is incorporated herein by reference in its entirety.

### TECHNICAL FIELD

The subject matter described herein relates to IPsec processing. More specifically, the subject matter relates to methods, systems, and computer readable media for offloading IPsec processing using an IPsec transport mode or tunnel mode proxy mechanism.

### BACKGROUND

IPsec is a protocol suite for securing IP communications by authenticating and encrypting each IP packet of a communication session. IPsec includes protocols for establishing mutual authentication between agents at the beginning of the session and negotiation of cryptographic keys to be used during the session. IPsec is an end-to-end security scheme operating in the Internet Protocol (IP) Layer of the Internet Protocol Suite. It can be used for protecting data flows between a pair of hosts (host-to-host), between a pair of security gateways (network-to-network), or between a security gateway and a host (network-to-host). Internet Key Exchange (IKEv1 or IKEv2) is a protocol used to set up a security association (SA) in the IPsec protocol suite. IKE uses a key exchange to set up a shared session secret, from which cryptographic keys may be derived. Public key techniques or, alternatively, a pre-shared key, may be used to mutually authenticate the communicating parties. Encapsulating security payload (ESP) is a member of the IPsec protocol suite (ESP operates directly on top of IP) and provides origin authenticity, integrity, and confidentiality protection of packets. Unlike authentication header (AH), ESP does not protect the IP packet header. However, in tunnel mode, where the entire original IP packet is encapsulated with a new packet header added, ESP protection is afforded to the whole inner IP packet (including the inner header) while the outer header remains unprotected. IPsec is defined in Internet engineering task force (IETF) request for comments (RFC) 4301 and 4309 which are incorporated by reference herein in their entireties. IKE is defined in IETF RFC 5996 which is incorporated by reference herein in its entirety. ESP is defined in IETF RFC 2406 which is incorporated by reference herein in its entirety.

IPsec supports two main modes of operation: transport mode and tunnel mode. In transport mode, which is used for host-to-host communications, only the payload of the IP packet is encrypted and/or authenticated. Thus, the packet may be routed normally because the IP header is neither modified nor encrypted. In tunnel mode, by contrast, the entire IP packet is encrypted and/or authenticated and then encapsulated into a new IP packet with a new IP header. Tunnel mode may be used for network-to-network communications (e.g. virtual private networks) and host-to-network communications (e.g. remote user access) or alternatively for direct host-to-host communication when transport mode cannot be used.

Conventionally, IPsec and IKE packet processing is only performed by a gateway if the destination IP address of the packet is that of an interface on the gateway (i.e., locally terminated). All other packets that are not locally terminated are forwarded normally. FIG. 1A illustrates a conventional IPsec transport mode scenario in which packets that are not locally terminated are forwarded normally. Referring to FIG. 1A, IP address A is assigned to an interface on application host 100, and IP address B is assigned to an interface on application host 108. An IKE/non-IKE session may be established between hosts 100 and 108 may be terminated at each application host 100 and 108, where IKE related data, IPsec security policies and/or security associations are configured on application hosts 100 and 108. It is appreciated that gateway 102 is not involved in any IPsec interaction other than to simply forward ESP packets and IKE packets between application hosts 100 and 108 as a gateway router normally would. Thus, unencrypted IPsec session packets 104 (as indicated by a dashed line) associated with the session may originate from an application on host A 100 and may be sent internally to a networking stack that is capable of performing IPsec processing. The networking stack performs IPsec processing on the packets in order to partially encrypt them (i.e., the payload is encrypted while the header is unencrypted in transport mode). Partially encrypted IPsec session packets 106 (as indicated by a solid line) may be transmitted to gateway 102 which may examine and route packets 106 to destination host 108 based on their unencrypted header information.

FIG. 1B is a diagram showing a more detailed view of the conventional transport mode session shown in FIG. 1A. Referring to FIG. 1B, hosts A 100 and B 108 each perform their own IPsec processing. For example, host A 100 may include an application 110 and an IKE daemon/process 112 which may communicate with networking stack 114. In this scenario, networking stack 114 may include IPsec processing module 116 for performing IPsec processing. IKE daemon/process 112 on application host A 100 may communicate with IKE daemon/process 126 on host B 108 in order to perform initial IPsec security association (SA) setup. Gateway C 102 may be completely uninvolved other than to route packets between the two networks. Thus, encrypted IPsec session packets 106 may flow directly from host A 100 to host B 108 through networks 118 and 122. Network gateway C 102 may route the encrypted packets from host A 100 to the next hop network 122, but does not perform any IPsec processing on the packets (as indicated by the absence of an IPsec processing module in networking stack 120).

FIG. 2 illustrates a conventional tunnel mode (host-to-host) scenario in which packets that are not locally terminated on the security gateway are forwarded normally to the destination node without any IPsec processing by the security gateway. Referring to FIG. 2, IPsec session gateway IP address A′ (i.e., the outer packet address) and host IP address A (i.e., the inner packet address) are identical and are assigned to an interface on application host A 100. Likewise, B and B′ are identical and are assigned to host 108. An IKE or static IPsec session is configured to exist on hosts 100 and 108 (i.e., configuration of IKE related data, IPsec security policies and/or security associations) and is terminated locally on application host 100 and 108. Gateway 102 may route encrypted IPsec session packets 106 (e.g., ESP packets) normally without performing any IPsec processing on in-transit packets.

FIG. 3A illustrates a conventional tunnel mode: host-to-gateway scenario in which a security gateway encapsulates and encrypts packets that are destined to a host (100) or network situated behind the security gateway for the purpose of protecting that host or network. Referring to FIG. 3A, the IPsec tunnel gateway IP address C is assigned to gateway 102 and host IP address A is assigned to an interface on application host 100. On host 108 address B and B′ are identical and represent the host and gateway IP address of the tunnel respectively. For example, both host IP address A and B are assigned to an interface on application hosts 100 and 108 and unencrypted IPsec session packets 104 are terminated locally on application host 100. The IKE session/static IPsec session is configured to exist on the application host 108 and gateway 102 (i.e., configuring of IKE related data, IPsec security policies and/or security associations). Gateway 102 accepts unencrypted packets 104 from host 100 and forwards encrypted IPsec session packets 106 (e.g., ESP packets) to the final destination host 108. When encrypted IPsec session packets 106 are received, decrypted and decapsulated by gateway blade 102, the inner portion of IPsec session packets 106 may then be forwarded to their final destination (i.e., application host A 100) as unencrypted packets 104.

FIG. 3B is a diagram showing a more detailed view of the conventional tunnel mode: gateway-to-host session shown in FIG. 3A. Referring to FIG. 3B, application host B 108 may perform its own IPsec processing whereas host A 100 has offloaded IPsec processing to gateway C 102. In the configuration shown in FIG. 3B, the packet source address for path 300 has been rewritten, by gateway C 102, to be “From” the address of gateway C 102 and to the address of host B 108 instead of from host A 100 to host B 108. As a result, host B 108 is aware that tunnel-mode is employed and host B 108 must be reconfigured to address packets for the session to gateway C 102 instead of host A 100. This has several drawbacks, including burdens on system administrators for reconfiguring host B 108 for tunnel mode, which may be compounded for large numbers of hosts or by hosts that do not support tunnel-mode configurations. On the return path, once the packet is decrypted by gateway C 102 and tunnel-mode headers are decapsulated, packets originated as from host B 108 to gateway C 102 are rewritten so that they are addressed from host B 108 to host A 100. Here, IKE daemons/processes 112 and 126 may communicate from gateway C 102 to host B 108 in order to perform initial IPsec SA setup. Host A 100 may be completely uninvolved and, in most cases, may be completely unaware that IPsec processing is being performed further in the network.

As mentioned above, one problem with moving IKE daemons/processes and IPsec processing functionality to the network gateway by using an IPSec tunnel mode session rather than a IPSec transport mode session is that the destination host/far-end node will be aware that the gateway is encrypting and re-addressing packets to it. As a result, the destination host/far-end node must be reconfigured to address packets for the session to the gateway instead of to the application host, which places a burden on system administrators.

Another problem associated with conventional IPsec processing by application blades is that the CPU resources on the application blades may be overburdened, thereby negatively impacting the revenue generating capabilities of existing applications executed by the application blades.

Accordingly, in light of these difficulties, a need exists for improved methods, systems, and computer readable media for offloading IPsec processing from application hosts in a manner that is transparent to destination hosts/far-end nodes.

### SUMMARY

Methods, systems, and computer readable media for offloading IPsec processing from application hosts using an IPsec proxy mechanism are disclosed. According to one method, at least one of unencrypted, IPsec, and Internet key exchange (IKE) packets transmitted between a first application host and a second application host are intercepted by a network gateway. The network gateway performs all IKE and IPsec-related processing for the at least one of the unencrypted, IPsec, and IKE packets on behalf of the first application host such that the second application host is unaware that IPsec processing is being performed by the network gateway.

A network gateway for offloading IPsec processing from application blades using an IPsec tunnel and transport proxy mechanism is also disclosed. The network gateway includes a communications module for intercepting at least one of unencrypted, IPsec, and Internet key exchange (IKE) packets transmitted between a first application host and a second application host. The network gateway further includes an IPsec offload module for performing all IKE and IPsec-related processing for the IPsec and IKE packets on behalf of the first application host such that the second application host is unaware that IPsec processing is being performed by the network gateway.

The subject matter described herein for offloading IPsec processing from application blades or hosts using an IPsec tunnel or transport proxy mechanisms may be implemented using a non-transitory computer readable medium to having stored thereon executable instructions that when executed by the processor of a computer control the processor to perform steps. Exemplary non-transitory computer readable media suitable for implementing the subject matter described herein include chip memory devices or disk memory devices accessible by a processor, programmable logic devices, and application specific integrated circuits. In addition, a computer readable medium that implements the subject matter described herein may be located on a single computing platform or may be distributed across plural computing platforms.

### BRIEF DESCRIPTION OF THE DRAWINGS

The subject matter described herein will now be explained with reference to the accompanying drawings of which:

FIG. 1A is a network diagram showing a conventional “transport mode” scenario in which packets that are not “locally terminated” on a security gateway are forwarded normally;

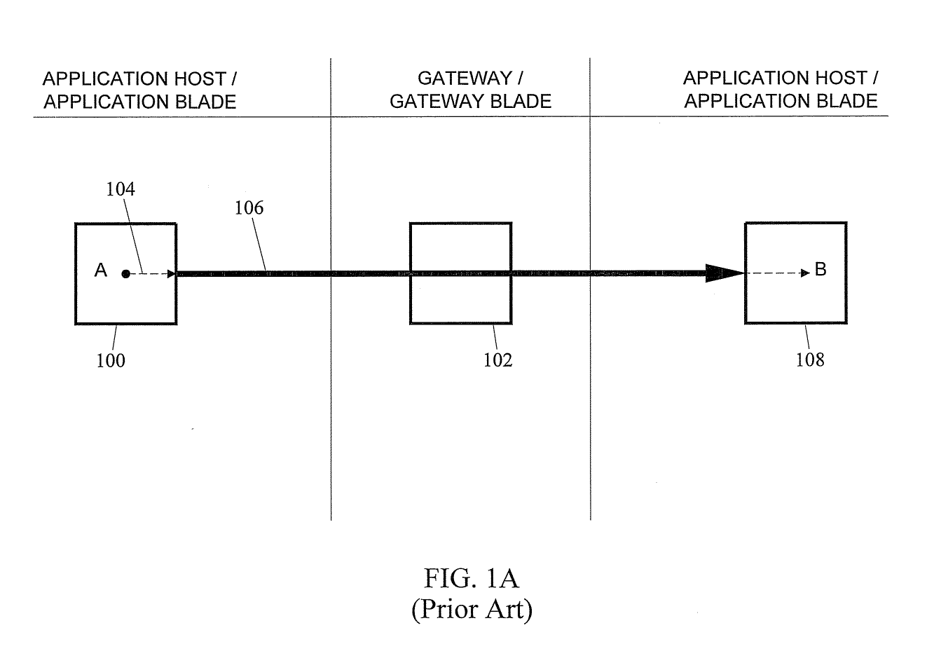

FIG. 1B is a diagram showing a more detailed view of the conventional “transport mode” session shown in FIG. 1A;

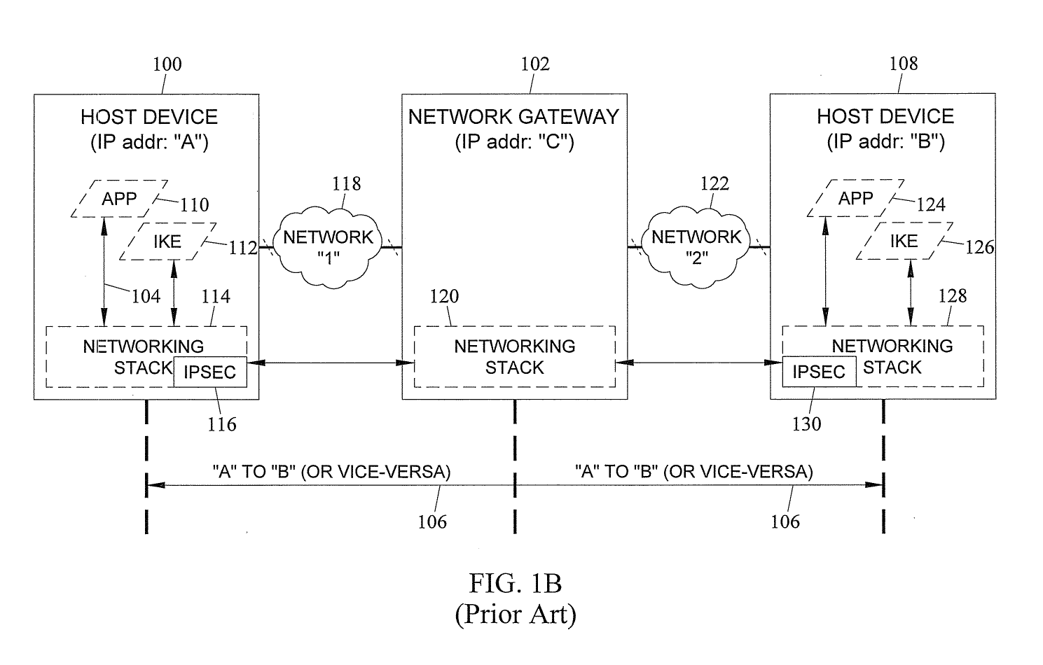

FIG. 2 is a network diagram showing a conventional “tunnel mode (host-to-host)” scenario in which packets that are not locally terminated on a security gateway are forwarded normally;

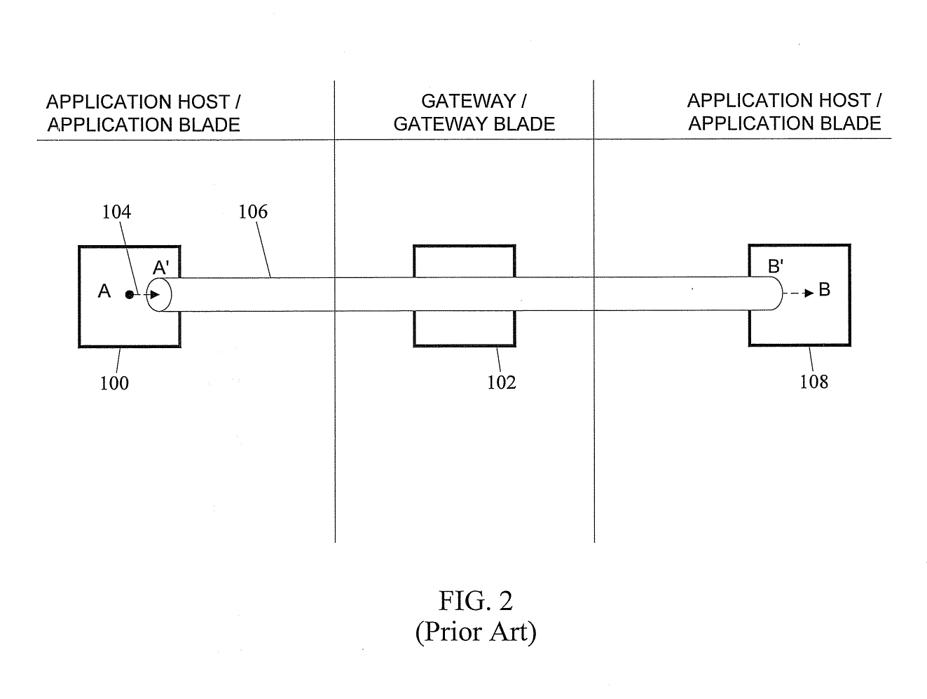

FIG. 3A is a network diagram showing a conventional “tunnel mode: host-to-gateway” scenario in which a security gateway performs IPsec processing on packets on behalf of an application host or network;

FIG. 3B is a diagram showing a more detailed view of the conventional “tunnel mode: gateway-to-host” session shown in FIG. 3A;

FIG. 4 is a flow chart showing exemplary steps for offloading IPsec processing from application blades using an IPsec proxy mechanism according to an embodiment of the subject matter described herein;

FIG. 5A is a network diagram showing a “transport mode” scenario for offloading IPsec processing from application blades using an IPsec proxy mechanism according to an embodiment of the subject matter described herein;

FIG. 5B is a network diagram showing a more detailed “transport mode” scenario for offloading IPsec processing from application blades using an IPsec proxy mechanism according to an embodiment of the subject matter described herein;

FIG. 6 is a network diagram showing a “tunnel mode: (host-to-host)” scenario for offloading IPsec processing from application blades using an IPsec proxy mechanism according to an embodiment of the subject matter described herein;

FIG. 7 is a network diagram showing a “tunnel mode: host-to-gateway” scenario for offloading IPsec processing from application blades using an IPsec proxy mechanism according to an embodiment of the subject matter described herein;

FIG. 8 is a block diagram showing exemplary functional components of an IPsec proxy mechanism suitable for offloading IPsec processing from application blades according to an embodiment of the subject matter described herein; and

FIG. 9 is a block diagram showing exemplary functional components of an IPsec proxy mechanism suitable for offloading IPsec processing from application blades according to an embodiment of the subject matter described herein.

### DETAILED DESCRIPTION

The subject matter described herein includes methods, systems, and computer readable media for offloading IPsec processing from application hosts to gateways using an IPsec proxy mechanism. The IPsec proxy mechanism described herein enables a network gateway to transparently perform IPsec-related tasks on behalf of an application host. In one embodiment, this may include offloading IPsec processing from application blades to gateway blades within a multi-blade shelf and these tasks may include both control plane and data plane related components. The IPsec proxy mechanism further allows offloading of IPsec processing from application blades and is designed to extend the capabilities of the IKE subsystem and be compatible with non-IKE (e.g., statically defined) sessions. In contrast to normal gateway IPsec processing where the destination IP address of a packet is assigned to an interface on the gateway blade, according to the subject matter described herein the destination IP address of a packet may be the address of an application blade. The application blade may be logically situated “behind” the gateway in the network topology. By offloading IPsec processing from application blades, CPU usage on the application blades may be reduced, thereby increasing the amount of CPU resources available for revenue-generating customer applications. Also, IPsec offloading enables systems to take advantage of specialized IPsec processing hardware that is typically available on gateway blades.

Other advantages of the IPsec proxy mechanism described herein include the ability to leverage specialized IPsec hardware on the gateway to boost IPsec processing performance, to leverage existing IKE and IPsec sparing strategies by making use of high availability (HA) services on the gateway, maximize the use of Federal information processing standards (FIPS-1) certified code on the gateway, reduce licensing costs by reducing the number of blades requiring IPsec, and reduce system complexity by limiting IPsec processing and sparing to fewer blades.

It is appreciated that the subject matter described herein, in addition to being applied to IPsec transport mode implementations, may also be applied to an implementation of IPsec tunnel-mode known as “host-to-host” tunnel mode. In host-to-host tunnel mode, two host nodes establish a tunnel-mode session directly between themselves without involving an intermediate security gateway. In addition, the subject matter described herein may also apply to host-to-gateway variants of tunnel mode if proxy mode is applied to the “host” side of the “host-to-gateway” configuration. However, the subject matter described herein may not be applied to tunnel-mode sessions known as gateway-to-gateway mode, subnet-to-subnet mode, or host-to-gateway mode where proxy is attempted on the “gateway” side of the “host-to-gateway” configuration. Exemplary implementations of the subject matter described herein for offloading IPsec processing from application hosts (e.g., blades or dedicated network devices) to network gateways/gateway blades, as applied to transport-mode, host-to-host tunnel mode, and host-to-gateway tunnel mode, will be described in greater detail below.

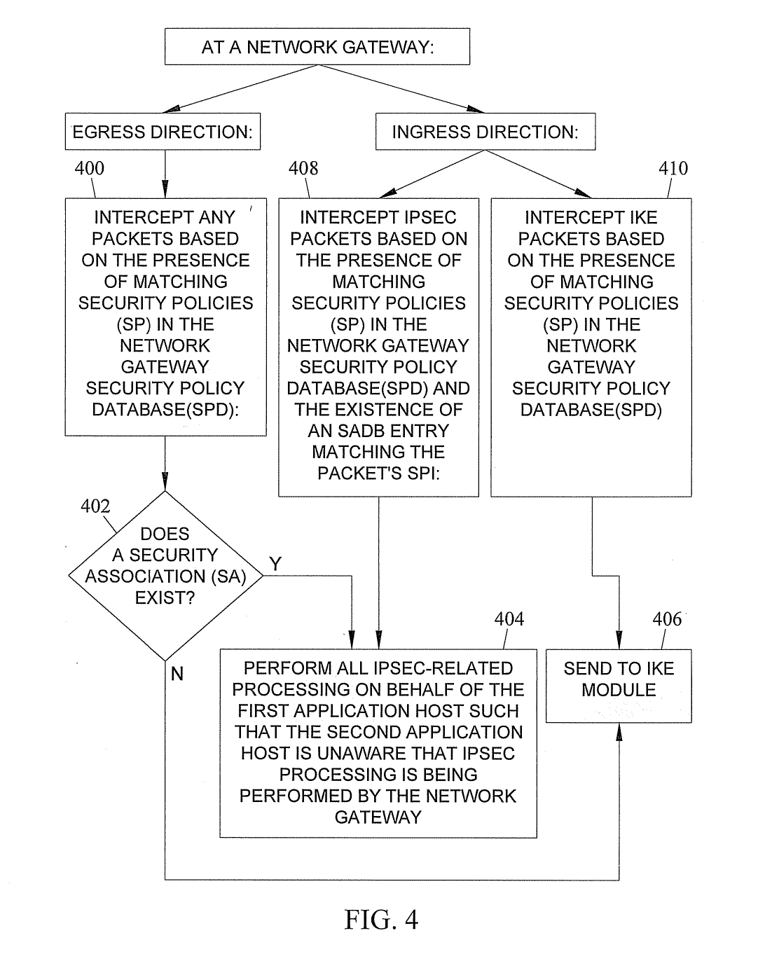

FIG. 4 is a flow chart showing exemplary steps for offloading IPsec processing from application hosts using an IPsec proxy mechanism according to an embodiment of the subject matter described herein. Referring to FIG. 4, in the egress direction, at step 400, packets may be intercepted by the gateway (on behalf of an application host/blade) based on the presence of matching security policies in a network gateway security policy database (SPD) or a security association database (SADB). Intercepting the IPsec and IKE packets may include intercepting IPsec and IKE packets in a dedicated fastpath or an operating system kernel networking stack. IPsec policies maintained in the SPD may define which traffic is to be protected and how it is to be protected. The sending host may determine which policy is appropriate for a packet based on various “selectors” in the SPD. Exemplary selectors include: source and destination IP addresses, transport layer protocols (e.g., SCTP, TCP or UDP), or source and destination ports. SPD indicates what the policy is for a particular packet. If a packet requires IPsec processing, the packet may be passed to an IPsec module for processing.

Also in the egress direction, at step 402, it may be determined whether a security association exists for the packets intercepted in step 400. If a SA exists (i.e., a packet matches an SPD entry), control may proceed to step 404 where all IPsec-related processing for the IPsec and IKE packets may be performed on behalf of the application host. Alternatively, if no SA exists, control may proceed to step 406 where the packet may be sent to a local IKE module.

At step 404, all IPsec-related processing for the IPsec and IKE packets may be performed on behalf of the application host such that the second application host is unaware that IPsec processing is being performed by the gateway. Performing IPsec-related processing on behalf of the application host may also include reassembling, at the gateway, fragmented packets prior to performing IPsec processing and encrypting and encapsulating the packet prior to forwarding the packet to a next-hop router.

In the ingress direction, at step 408, IPsec packets may be intercepted based on the presence of matching security policies in the network gateway SPD and the existence of an SADB entry matching the packet's SPI. If a matching entry is found, control may proceed to step 404 where all IPsec-related processing for the IPsec and IKE packets may be performed on behalf of the application host.

Also in the ingress direction, at step 410, IKE packets may be intercepted based on the presence of matching security policies in the network gateway SPD. It may be determined whether an IKE packet matches an existing SPD entry and, if so, control may proceed to step 406 where the packet may be forwarded to a local IKE module for processing.

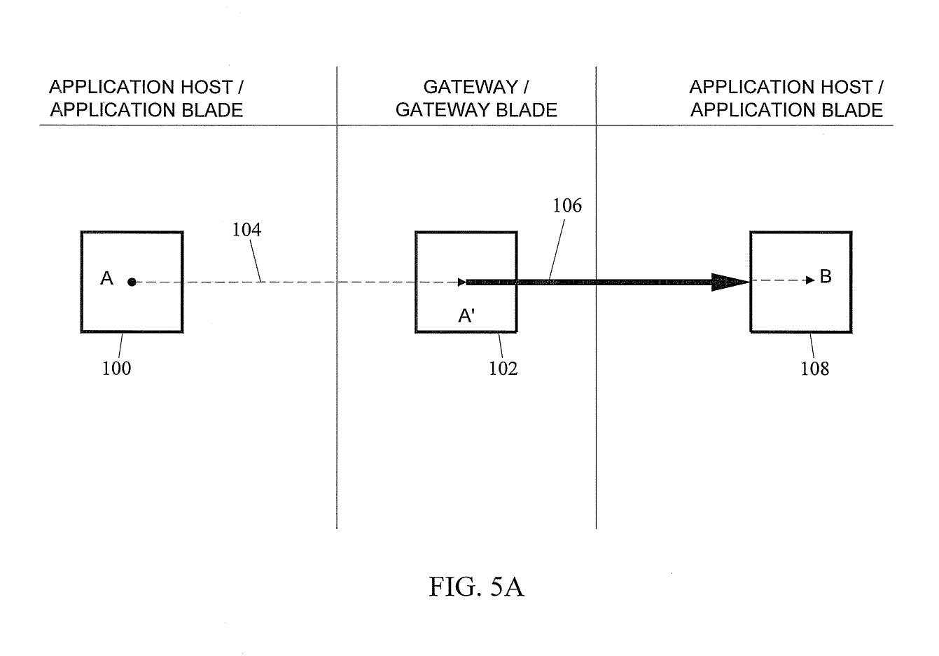

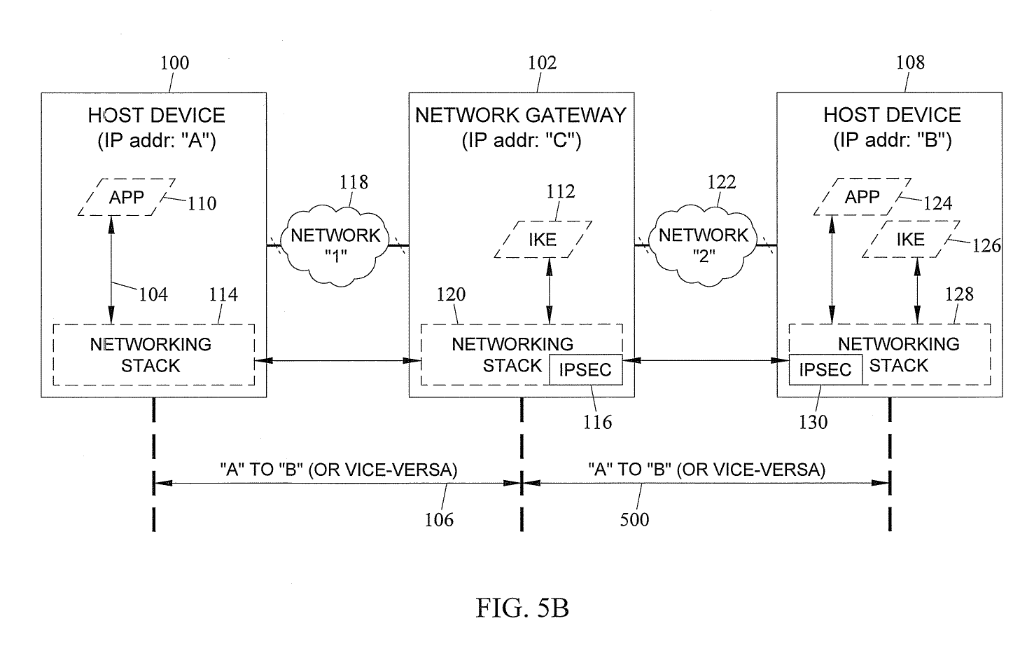

FIG. 5A is a network diagram showing a “transport mode” scenario for offloading IPsec processing from application blades using an IPsec proxy mechanism according to an embodiment of the subject matter described herein. Referring to FIG. 5A, gateway 102 may no longer act as a regular routing gateway. Instead, gateway 102 may perform all IPsec processing on behalf of application host 100. For example, an application IP address A may be assigned to an interface on application host 100. An IKE/static IPsec session may be configured to exist on gateway 102 that includes configuration of IKE related data, IPsec security policies and/or security associations. Because the IP address may not be assigned to gateway 102, yet there may exist IPsec configuration data related to the IPsec session, packets associated with the IPsec session may be intercepted and processed at gateway 102. In the ingress direction (i.e., received by host A 100), encrypted IPsec session packets 106 associated with the IPsec session may be decrypted by gateway 102 and unencrypted IPsec session packets 104 may be forwarded to host A 100. In the egress direction (i.e., sent by host A 100), unencrypted IPsec session packets 104 may be partially encrypted (i.e., payload is encrypted and header is unencrypted in transport mode) by gateway 102 and partially encrypted IPsec session packets 106 may be forwarded to a next-hop router for ultimate delivery to application host B 108.

FIG. 5B is a network diagram showing a more detailed “transport mode” scenario for offloading IPsec processing from application blades using an IPsec proxy mechanism according to an embodiment of the subject matter described herein. Referring to FIG. 5B, host B 108 performs its own IPsec processing and gateway C 102 performs IPsec processing on behalf of host A 100 in a way that is transparent to host B 108 and, therefore, does not require reconfiguration of host B 108. As a result, IPsec processing may be successfully offloaded from host A 100, while host B 108 may continue to maintain its original configuration and be unaware of the details of IPsec processing performed by gateway C 102 on behalf of host A 100.

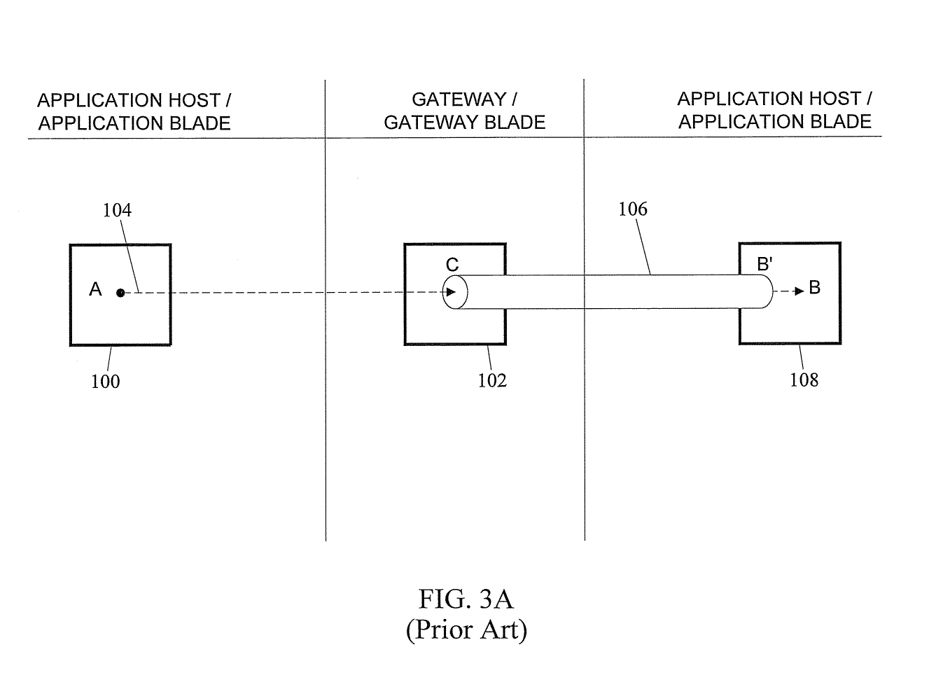

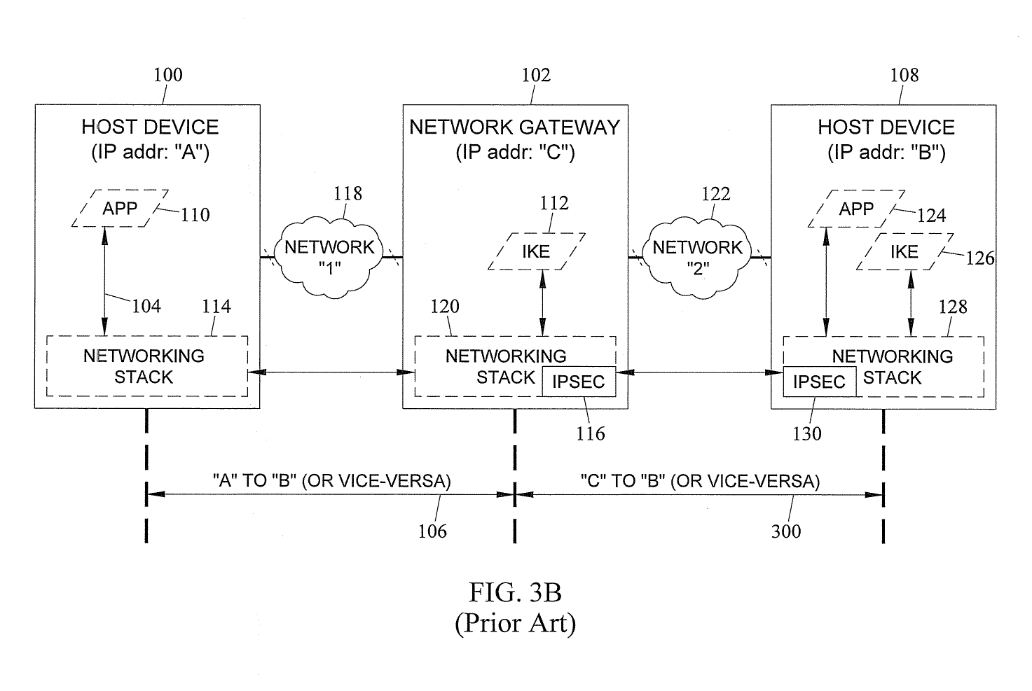

Here, IKE daemons/processes 112 and 126 communicate from gateway C 102 to host B 108 in order to perform initial IPsec SA setup. A difference between this approach and the tunnel-mode approach shown in FIG. 3B is that, here, gateway C 108 may pretend to be host A 100 so that the source address in all outgoing packets 500 is set to host address A 100 rather than the address of gateway C 102. As a result, this solution is transparent to far-end node host B 108.

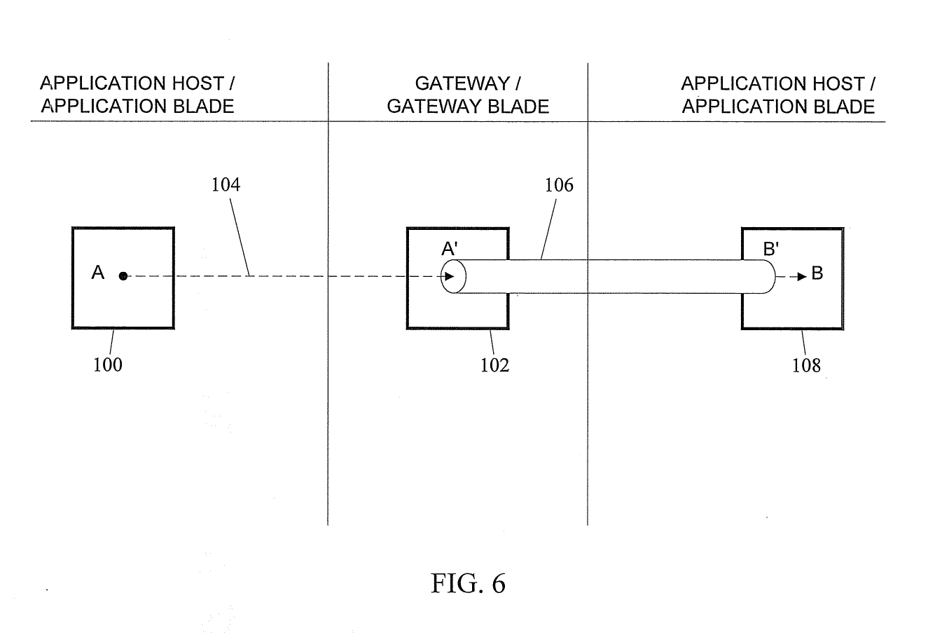

FIG. 6 is a network diagram showing a “tunnel mode: host-to-host” scenario for offloading IPsec processing from application blades using an IPsec proxy mechanism according to an embodiment of the subject matter described herein. Referring to FIG. 6, in tunnel mode both the inner IP address and the outer IP address are identical. Yet in contrast to conventional host-to-host implementations where the IPsec session is terminated at application host A 100, here, the IPsec session may be terminated at gateway C 102 while maintaining the same IP address A for both the encrypted inner and outer portions of the packets associated with the IPsec session. Thus, IPsec session gateway IP address A′ (i.e., outer packet address) and host IP address A (i.e., inner packet address) may each be assigned to an interface on application host A 100. IKE/static IPsec session may be configured to exist on gateway 102 (i.e., configuring of IKE related data, IPsec security policies and/or security associations). Because the gateway IP address may not be assigned to gateway 102 yet there may exist related IPsec configuration data, the IPsec session packets 104 may be intercepted and processed on gateway 102. In the ingress direction, IPsec session packets 104 may be decrypted and decapsulated on gateway 102 and the decrypted IPsec session packets 106 (i.e., inner) then be forwarded to its final destination. In the egress direction, the unencrypted packets 104 may be encrypted and forwarded to the next-hop router as encrypted IPsec packets 106. In this scenario, gateway 102 no longer acts as a regular routing gateway. Instead, gateway 102 may perform all IPsec processing on behalf of application host 100.

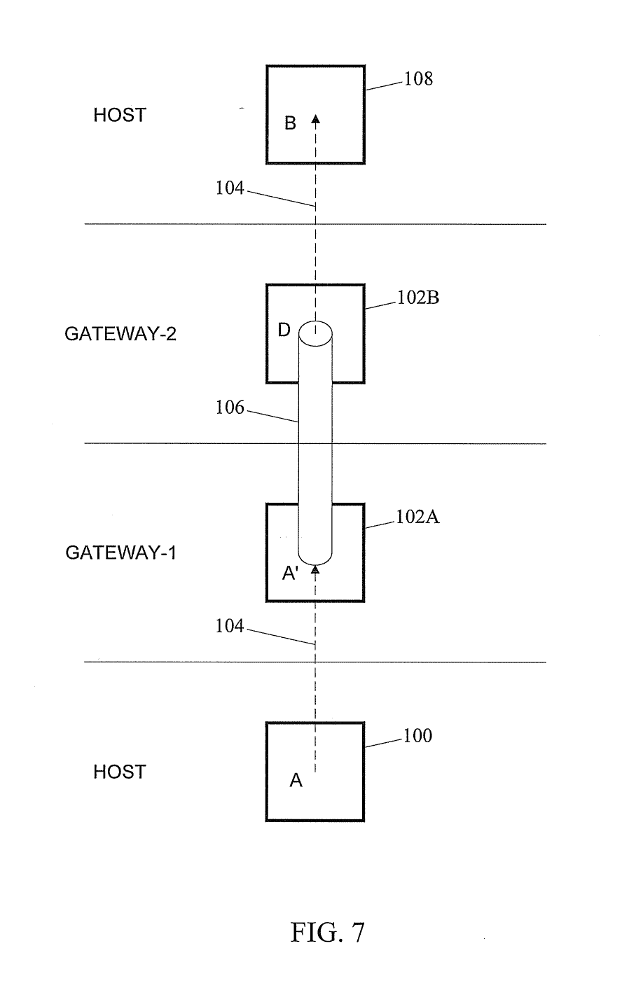

FIG. 7 is a network diagram showing a host-to-gateway scenario for offloading IPsec processing from application blades using an IPsec proxy mechanism applied on the host side of the connection according to an embodiment of the subject matter described herein. Referring to FIG. 7, it may be appreciated that IP addresses A and A′ are associated with one side of tunnel 106 while the other side of tunnel 106 has D and B as tunnel addresses. The IPsec session gateway IP address and host IP address are identical and both addresses are assigned to an interface on application host 100. In this scenario, a first gateway 102A may perform IPsec on behalf of application host 100 using the proxy mechanism described herein while a second gateway 102B may use conventional technologies to perform the “gateway” side of the “host-to-gateway” configuration shown. The IKE session or static IPsec session may be configured to exist on gateways 102A and 102B (i.e., configuring of IKE related data, IPsec security policies and/or security associations). Because the gateway IP address A may not be assigned to gateway 102A and related IPsec configuration data may exist, the IPsec session may be intercepted and processed on gateway 102A on behalf of host 100. In the ingress direction, the IPsec packet may be decrypted and decapsulated on gateway 102A, the inner packet may then be forwarded to its final destination (i.e., application host 100). In the egress direction, unencrypted packet 104 may be encrypted and forwarded to a next-hop router. In this scenario, gateway 102A no longer acts as a regular routing gateway, but instead performs all IPsec processing on behalf of the application blade 100. In contrast to the interaction between host 100 and gateway 102A, gateway 102B may use conventional technologies to perform IPsec processing only on packets sent to IP address B associated with host 108 and assigned to one of its interfaces.

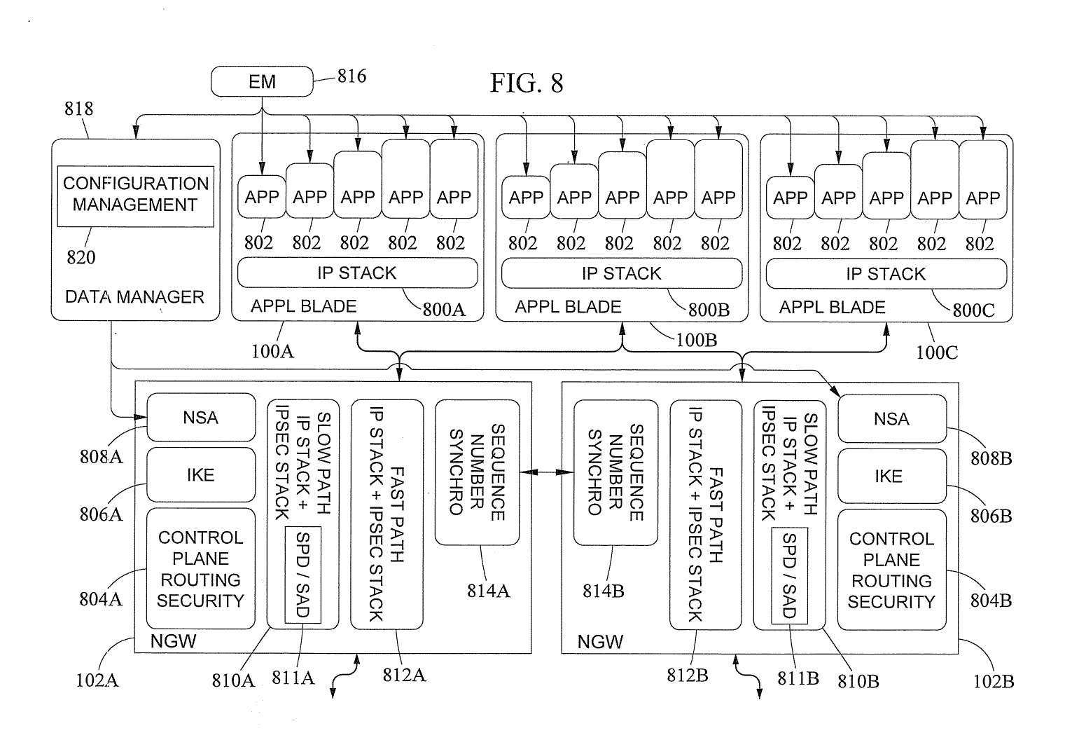

FIG. 8 is a block diagram showing exemplary functional components of an IPsec proxy mechanism suitable for offloading IPsec processing from application blades according to an embodiment of the subject matter described herein. Referring to FIG. 8, application blades 100A, 100B, and 100C include host devices capable of running a wide selection of generic applications, including gateway controller applications. For example, individual application hosts 100 may be blade-type devices that are installed in a multi-blade shelf (typically, a 14 slot or a 16 slot shelf, but could be a standalone blade or a 2-slot system as well). Application blades 100 may be configured to send all of their outgoing traffic via a set of network gateway blades, which may also be blades installed in the same multi-blade shelf (but not necessarily).

IP stacks 800A, 800B, and 800C may implement an IP networking stack (i.e., sending and receiving IP packets on the network). IP stacks 800 may be part of operating system software, such as a Linux kernel, which manages the resources and processes for each application or network gateway 802. In systems not employing the subject matter described herein, IP stack 800 is where IPsec processing would be applied to incoming/outgoing packets if an application 802 running on application host 100 required IPsec processing on its packets. However, according to the subject matter described herein IPsec processing is off-loaded and performed on NGW 102 instead of in the IP stack/Linux kernel 800 of application blades 100.

Applications 802 may include any generic application running on the application host devices that communicates to devices on the network. In one embodiment of a generic application, applications 802 may include gateway controllers (GWC). According to one possible embodiment, application 802 may include the C20 application executed on the GENiUS platform produced by GENBAND US, LLC, of Plano, Tex. The C20 is a network carrier-grade combined IP class 4 and class 5 softswitch and SIP multimedia application server. It provides advanced voice and multimedia services in a single platform that meets Internet multimedia subsystem (IMS) and IP standards and is configured to manage communications, perform calls, control IP phones and Voice over IP (VoIP) gateways, and/or deliver SIP-based multimedia service. GENBAND GENIUS is an all-IP Advanced Telecommunications Computing Architecture (ATCA) platform that includes application, call control, session border and security product functionality. The GENBAND GENiUS platform may be implemented using high-performance, high-density computing hardware and service availability forum (SAF)-compliant middleware, as well as may utilize other standards-based hardware, a hardened Linux operating system with telecom-specific extensions, and/or modular, fault tolerant middleware. GENBAND GENiUS may be used as a common platform for the C20 application as well as other applications 802. It may be appreciated that application 802 (also shown as 110 and 124 in FIGS. 5A and 3B) may be implemented as gateway controller (GWC), session server-trunk (SST), or session server-line (SSL) components of the C20.

NGW 102A and 102B are network gateway blades that include devices capable of acting as a layer-3 routing device, as well as providing security services (i.e., IPsec treatment of packets) to application blades 100 which it services. All traffic generated from application blades 100 or to application blades 100 must go through network gateway 102. Network gateway blades 102 may be configured as a single standalone entity or paired in a redundant set of two or more network gateway blades (e.g., 102A and 102B). According to one possible embodiment, gateway 102 may be implemented as one or more network gateway blades (NGW) within the GENiUS platform. Blades may be installed in a 16- or 14-slot ATCA shelf or other ATCA equipment types (e.g., rack-mount servers (RMS), standalone gateway nodes, etc.).

Control plane routing and security module 804A may be a subsystem responsible for managing the routing aspects of network gateway 102. In the embodiment shown in FIG. 8 where blades 102 are network gateway blades, NGWs 102 may perform other critical functions (other than simply IPsec processing), including various processes and routing implementations such as open shortest path first (OSPF), routing information protocol (RIP), bidirectional forwarding detection (BFD), link aggregation control protocol (LACP), border gateway protocol (BGP), etc.

IKE module 806A and 806B may be a subsystem, daemon, or process for interacting with another IKE process, running on another node in the network, in order to dynamically negotiate a set of IPsec security association parameters. These parameters include things such as: encryption algorithm and keys, authentication algorithm and keys, expiry lifetime values, and other associated attributes. Negotiations are triggered either from the remote node requesting a security association, or from an outgoing packet (originated by an application running on an application blade) which arrived at the network gateway but no security association was present to service the packet. Once a successful negotiation has completed, the IKE process installs a security association in the IPsec stack 800.

Network Security Agent (NSA) 808A and 808B is subsystem tasked with downloading IPsec configuration data from data manager (DM) blade 818 and installing it on the local network gateway 102. NSA 808 monitors the local IPsec configuration to ensure that it always reflects exactly the IPsec Configuration stored in the DM's 818 configuration data.

Slow path IP stack & IPsec stack 810A and 810B/fast path IP stack & IPsec stack 812A and 812B perform similar tasks. The difference is that the “slow path” is implemented as a normal operation system networking stack (i.e., a Linux Kernel) with all of the robustness and features that would normally be found in a full-fledged networking stack. The “fast path” is a streamlined/optimized version of this same software that is often executed on specialized hardware (network processing unit (NPU)) for extremely fast processing; often wire-speed processing. The trade-off between the two is that the “fast path” is not capable of handling many “out of the ordinary” conditions (i.e., complex route lookups, packets requiring special handling, etc). Packets requiring special processing are shunted to the “slow path” processor which has all the capabilities of a normal networking stack. Both stacks 810 and 812 are capable of performing IPsec processing and both are capable of performing IPsec processing on behalf of an application host 100A, 100B, or 100C.

IPSec policies may be maintained in the security policy database (SPD) 811A and 811B. IPSec policies define which traffic to be protected, how it is to be protected, and with whom to protect it. The sending host determines what policy is appropriate for the packet, depending on various “selectors” by querying SPD. Exemplary selectors include: source and destination IP addresses, transport layer protocols (e.g., SCTP, TCP or UDP), or source and destination ports. SPD indicates what the policy is for a particular packet. If a packet requires IPsec processing, the packet may be passed to an IPsec module for processing.

IPSec security associations are stored in the security association database (SAD). Each security association has an entry in SAD. Security association entries in the SAD are indexed by the three security association properties: destination IP address, IPSec protocol, security parameter index (SPI).

Sequence number synchronization module 814A and 814B refers to synchronization dynamic security association data between two (or more) redundant network security blades. As outgoing packets are processed by the IPsec stack each packet is tagged with an outgoing sequence number. This sequence number is used by the receiving node to detect whether a packet is duplicated or stale. In some scenarios the receiving node may choose to discard packets to prevent or stop attacks from the network. For this reason, it is crucial that the sending node always send a monotonically increasing sequence number. This task is simple on a single network gateway blade, but when two or more network gateway blades are acting as a redundant group special treatment is required to ensure that sequence numbers sent in all packets continue to be received as a single monotonically increasing value at the receiving node.

Gateway controller element manager (GWC EM) is illustrated for context only and its purpose is to provide a single user-interface (often a Graphical UI) for an end customer to configure a series of GWC applications.

Data manager (DM) 818 may be a special application-blade whose purpose is to act as the central storage location for all of the blades configured in the multi-blade shelf. DM 818 may host a database as well as a user-interface for configuring the various blades in the shelf. DM 818 may also host one or more physical storage devices (i.e., hard disk drive or solid-state drive) which can be used by the other blades in the shelf for storing billing data, diagnostics data, configuration data, etc.

Configuration management (CM) module 820 may represent the configuration management entity on DM 818 responsible for feeding configuration data down to application blades 100 or network gateway blades 102.

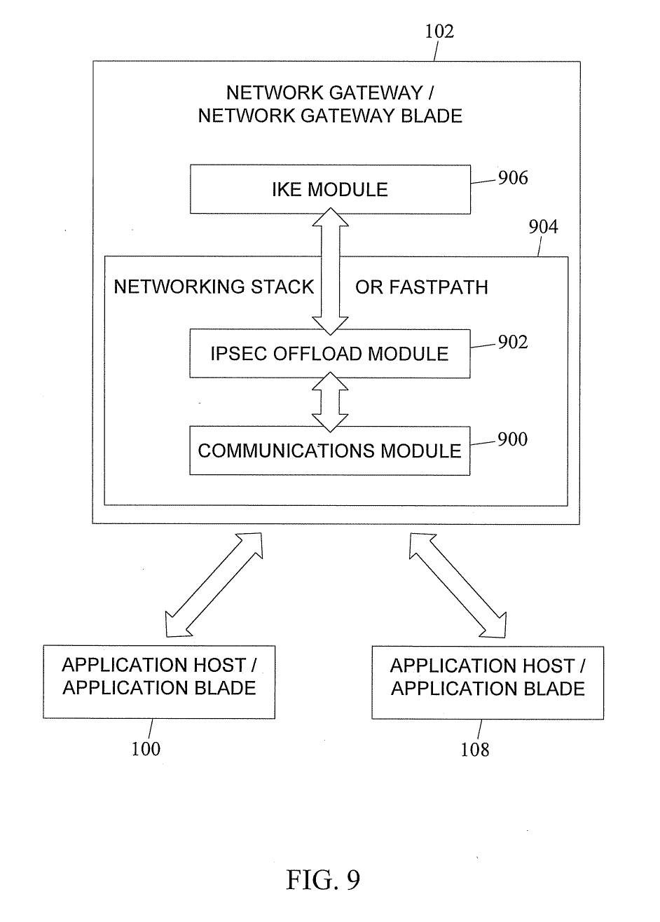

FIG. 9 is a block diagram showing exemplary functional components of an IPsec proxy mechanism suitable for offloading IPsec processing from application blades according to an embodiment of the subject matter described herein. Referring to FIG. 9, network gateway/network gateway blade 102 may include a communications module 900, embedded within a kernel networking stack or dedicated fastpath 904, for intercepting IPsec and Internet key exchange (IKE) packets transmitted between a first application host and a second application host. Communications module 900 may send and receive packets transmitted between application hosts/blades 100 and 108. For example, communications module 900 may be configured to intercept the IPsec and IKE packets in a dedicated fastpath or an operating system kernel networking stack. Additionally, communications module 900 may be configured to, in the ingress direction, determine whether an IKE packet is related to an existing IPsec protection policy and, in response to determining that the IKE packet is related to an existing IPsec protection policy, to intercept the IKE packet and send the IKE packet to a local IKE module (which may be incorporated into IPsec offload module 902 or may be separately located 906) for processing.

IPsec offload module 902 may perform all IPsec-related processing for the IPsec and IKE packets on behalf of the first application host such that the second application host is unaware that IPsec processing is being performed by the network gateway. IPsec offload module 902 may be configured to, in the ingress direction, determine whether an ESP packet's SPI value matches an existing entry in a SADB (not shown) and, in response to determining that the ESP packet's SPI value matches an entry in the SADB, decrypt and decapsulate the ESP packet (and forwarding the packet to a destination blade). IPsec offload module 902 may also be configured to, in the egress direction, determine whether one of the IPsec and IKE packets matches a SPD (not shown) entry and, in response to determining that one of the IPsec and IKE packets matches an SPD entry, encrypt and encapsulate the packet prior to forwarding the packet to a next-hop router. In one embodiment, IPsec offload module 902 may be configured to reassemble, at the gateway, fragmented packets prior performing IPsec processing. Finally, IPsec offload module 902 may be configured to perform all IPsec-related processing for the unencrypted, IPsec, and/or IKE packets on behalf of application host 100 for at least one of an IPsec transport mode session, an IPsec host-to-host tunnel mode session, and an IPsec gateway-to-host tunnel mode session.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for offloading Internet Protocol security (IPsec) processing from a host device to a network gateway device using an IPsec proxy mechanism, the method comprising:
at a network gateway:
intercepting at least one of unencrypted, IPsec, and Internet key exchange (IKE) packets transmitted between a first application host and a second application host; and
performing all IKE and IPsec-related processing for the at least one of unencrypted, IPsec, and IKE packets on behalf of the first application host such that the second application host is unaware that IPsec processing is being performed by the network gateway.

2. The method of claim 1 wherein intercepting the at least one unencrypted, IPsec, and IKE packets includes intercepting unencrypted IPsec and IKE packets in a dedicated fastpath or an operating system kernel networking stack.

3. The method of claim 1 wherein intercepting the at least one unencrypted, IPsec, and IKE packets includes, in the ingress direction, determining whether an IKE packet which is not addressed to the gateway is related to an existing IPsec protection policy and, in response to determining that the IKE packet is related to an existing IPsec protection policy, intercepting the IKE packet and sending the IKE packet to a local IKE module for processing.

4. The method of claim 1 wherein performing all IPsec-related processing for the at least one unencrypted, IPsec, and IKE packets on behalf of the first application host includes, in the ingress direction, determining whether an encapsulating security payload (ESP) packet which is not addressed to the gateway has a security parameter index (SPI) value which matches an existing entry in a security association database (SADB) and, in response to determining that the ESP packet's SPI value matches an entry in the SADB, decrypting and decapsulating the ESP packet (and forwarding the packet to a destination blade).

5. The method of claim 1 wherein performing all IPsec-related processing for the at least one unencrypted, IPsec, and IKE packets on behalf of the first application host includes, in the egress direction, determining whether one of the unencrypted packets matches a security policy database (SPD) entry and, in response to determining that one of the packets matches an SPD entry, encrypting and encapsulating the packet prior to forwarding the packet to a next-hop router or triggering an IKE negotiation in cases where a security association (SA) corresponding to the SPD entry has not previously been installed in the SADB.

6. The method of claim 1 wherein performing all IPsec-related processing for the at least one unencrypted, IPsec, and IKE packets on behalf of the first application host includes reassembling, at the gateway, fragmented packets prior to performing IPsec processing.

7. The method of claim 1 wherein performing all IPsec-related processing for the at least one unencrypted, IPsec, and IKE packets on behalf of the first application host is performed for at least one of an IPsec transport mode session, an IPsec host-to-host tunnel mode session, and an IPsec host-to-gateway tunnel mode session.

8. A network gateway for offloading IPsec processing from application hosts using an IPsec proxy mechanism, the network gateway comprising:
a communications module for intercepting unencrypted IPsec and Internet key exchange (IKE) packets transmitted between a first application host and a second application host; and
an IPsec offload module for performing all IKE and IPsec-related processing for the at least one unencrypted, IPsec, and IKE packets on behalf of the first application host such that the second application host is unaware that IPsec processing is being performed by the network gateway.

9. The network gateway of claim 8 wherein the communications module is configured to intercept the unencrypted, IPsec and IKE packets in a dedicated fastpath or an operating system kernel.

10. The network gateway of claim 8 wherein the communications module is configured to, in the ingress direction, determine whether an IKE packet, which is not addressed to the gateway, is related to an existing IPsec protection policy and, in response to determining that the IKE packet is related to an existing IPsec protection policy, intercept the IKE packet and sending the IKE packet to a local IKE module for processing.

11. The network gateway of claim 8 wherein the IPsec offload module is configured to, in the ingress direction, determine whether an encapsulating security payload (ESP) packet which is not addressed to the gateway has a security parameter index (SPI) value which matches an existing entry in a security association database (SADB) and, in response to determining that the ESP packet's SPI value matches an entry in the SADB, decrypt and decapsulate the ESP packet (and forwarding the packet to a destination blade).

12. The network gateway of claim 8 wherein the IPsec offload module is configured to, in the egress direction, determine whether one of the unencrypted packets matches a security policy database (SPD) entry and, in response to determining that one of the packets matches an SPD entry, encrypt and encapsulate the packet prior to forwarding the packet to a next-hop router or trigger an IKE negotiation in cases where a security association (SA) has not previously been installed in the SADB.

13. The network gateway of claim 8 wherein the IPsec offload module is configured to reassemble, at the gateway, fragmented packets prior to performing IPsec processing.

14. The network gateway of claim 8 wherein the IPsec offload module is configured to perform all IPsec-related processing for the at least one unencrypted, IPsec, and IKE packets on behalf of the first application host for at least one of an IPsec transport mode session, an IPsec host-to-host tunnel mode session, and an IPsec host-to-gateway tunnel mode session.

15. The network gateway of claim 8 wherein the communications module and the IPsec offload module is located at a gateway blade and the communications module is configured to intercept packet from an application blade.

16. A non-transitory computer readable medium having stored thereon computer executable instructions that when executed by a processor of a computer control the computer to perform steps comprising:
at a network gateway:
intercepting at least one of unencrypted, IPsec, and Internet key exchange (IKE) packets transmitted between a first application host and a second application host; and
performing all IKE and IPsec-related processing for the at least one unencrypted, IPsec, and IKE packets on behalf of the first application host such that the second application host is unaware that IPsec processing is being performed by the network gateway.
